(19) United States
(12) Patent Application Publication
(10) Pub. No.: US 2026/0170643 A1
(43) Pub. Date: Jun. 18, 2026

(54) METHOD FOR ASSESSING QUALITY OF ECHOCARDIOGRAM IMAGE BASED ON FUSION OF IMAGE AND TEXT FEATURES

(71) Applicant: Union Hospital Tongji Medical College Huazhong University of Science and Technology, Wuhan (CN)

(72) Inventors: Li Zhang, Wuhan (CN); Ye Zhu, Wuhan (CN); Mingxing Xie, Wuhan (CN); Xin Yang, Wuhan (CN); Yiheng Dong, Wuhan (CN); Zisang Zhang, Wuhan (CN); Yuman Li, Wuhan (CN); Wenwen Chen, Wuhan (CN); Yuanting Quan, Wuhan (CN); Xuelin Hu, Wuhan (CN); Guangyu Xu, Wuhan (CN); Chun Wu, Wuhan (CN)

(21) Appl. No.: 19/398,259

(22) Filed: Nov. 24, 2025

(30) Foreign Application Priority Data
Dec. 13, 2024 (CN) 2024118351082

(51) Int. Cl. G06T 7/00

(52) U.S. Cl. CPC G06T 7/0012; G06T 2207/20081; G06T 2207/20221; G06T 2207/30048; G06T 2207/30168

(57) ABSTRACT

A method for assessing quality of an echocardiogram image based on fusion of image and text features is provided, which relates to the field of medical imaging technologies. The method includes performing feature extraction and classification by using a target detection model, aligning image features with quality control text features by using a visual-language feature alignment module, and performing sentence template selection, linear projection, and merging by using a large language model. The method utilizes cross-domain transfer of image and text features, to generate accurate and comprehensive echocardiogram image quality assessment reports, thereby enhancing interpretability and granularity of assessment results; introduces the target detection model to recognize and understand positional relationships of different anatomical structures within medical images, thereby providing rich medical domain prior knowledge for subsequent quality assessment, and achieving effective cross-domain transfer from natural images to echocardiograms; and introduces sentence templates to ensure consistency of quality control text.

### CROSS-REFERENCE TO RELATED APPLICATION

This application claims priority to Chinese Patent Application No. 202411835108.2, filed on Dec. 13, 2024, which is herein incorporated by reference in its entirety.

### TECHNICAL FIELD

The disclosure relates to the field of medical imaging technologies, and more particularly to a method for assessing quality of an echocardiogram image based on fusion of image and text features.

### BACKGROUND

Echocardiography is a non-invasive, real-time imaging advanced medical imaging technology, which is widely used in diagnosis of heart disease, monitoring of treatment progress, and assessment of cardiac function. However, influenced by multiple factors such as imaging conditions, skill and experience of the operator, and movement of human organs and tissues, the image quality of echocardiograms varies significantly. Low-quality images may suffer from issues like missing structural information and blurred boundaries, thereby affecting the diagnostic accuracy and decision-making efficiency of physicians. Therefore, accurately assessing the quality of echocardiograms plays an indispensable role in ensuring the effectiveness and reliability of diagnosis. In clinical practice, quality control of the echocardiogram images primarily relies on the experience and professional knowledge of physicians, which typically involves the manual selection of high-quality images from a large number of images for diagnosis. This method is not only inefficient but also highly subjective and inconsistent, as assessment results may vary significantly among different physicians.

A Chinese patent application with a title of a method and a system for assessing quality of an echocardiogram, and a terminal device, and an application No. CN202210991916.2 (corresponding to patent publication No. CN115345858A) discloses a method and a system for assessing quality of an echocardiogram, and a terminal device. The method includes constructing an echocardiogram quality assessment network model, collecting an echocardiogram image to be detected, inputting the echocardiogram image to be detected into the echocardiogram quality assessment network model, outputting, by the echocardiogram quality assessment network model, multiple echocardiogram quality control data, and performing a weighted calculation on the multiple echocardiogram quality control data to obtain a quality assessment score for the echocardiogram. However, training labels of the method are solely based on the subjective assessment of personnel with medical backgrounds selecting high-quality echocardiogram videos, which still exhibits significant observer variability and lacks objective indicators for assessing image quality. Furthermore, this method only considers image features and ignores the fusion of clinical text information, the assessment result lacks interpretability, and the generated assessment data is an unstructured score that is difficult to efficiently integrate with downstream medical information systems. A Chinese patent application with a title of echocardiographic image view recognition method and echocardiographic video view quality control method, and an application No. CN202310248785.3 (corresponding to patent publication No. CN116485721A) discloses an echocardiographic image view recognition method, an echocardiographic video view quality control method, an electronic device and a readable storage medium. However, its image quality control is only based on a predicted probability value of view classification, which lacks objective indicators for assessing the image quality of various structures within the echocardiogram, and lacks the experience of physicians in assessing image quality, resulting in the system being unable to provide fine-grained, anatomically specific quality feedback. A Chinese patent application with a title of a fetal ultrasound image quality control method and system, and an application No. CN 201610991842.7 (corresponding to patent publication No. CN106408566A) discloses a fetal ultrasound image quality control method and system. The method determines whether an area of a region of interest in the view accounts for more than ½ of a scanning area, whether the gastric bubble is fully displayed with clear boundaries, and whether the veins show a cord-like appearance and are continuous without interruption, thereby achieving quality control of fetal ultrasound images. This method uses objective indicators for various structures in the fetal abdominal ultrasound image to assess image quality and incorporates physician experience. Fetal abdominal ultrasound images primarily focus on the morphology and development of organs, whereas echocardiograms assess the structure and function of the heart. The differences in imaging targets determine that the focus and technical approaches for quality control assessment are distinct. Therefore, quality control methods targeting the fetal abdomen cannot meet the assessment needs of cardiac ultrasound images, especially in terms of processing dynamic cardiac imaging and multi-scale structures, which have technical limitations. Additionally, this method does not fuse text information and cannot output image quality assessment results in a form of descriptive text, which limits its applicability as a component of intelligent auxiliary diagnostic systems.

### SUMMARY

In order to overcome disadvantages in the related art, an objective of the disclosure is to provide a method for assessing quality of an echocardiogram image based on fusion of image and text features. By utilizing cross-domain transfer of image and text features, an accurate and comprehensive echocardiogram image quality assessment report is generated, thereby enhancing the interpretability and granularity of the assessment results. By introducing a target detection model, the system is enabled to recognize and understand positional relationships of different anatomical structures within medical images, thereby providing rich medical domain prior knowledge for subsequent quality assessment, and achieving effective cross-domain transfer from natural images to echocardiograms. By introducing sentence templates, the consistency of the quality control text is ensured.

In order to achieve the above objective, the disclosure provides the following solutions.

A method for assessing quality of an echocardiogram image based on fusion of image and text features includes:
performing, by using a pretrained target detection model, feature extraction and classification on cardiac anatomical structures in a target view image to obtain category label data and location data; where the target detection model includes: a feature extraction network, a region proposal network, a first region of interest (ROI) pooling sub-module, and a classification and regression module; the feature extraction network is configured to extract feature information from the cardiac anatomical structures in the target view image to obtain a first feature map; the region proposal network is configured to calculate a foreground confidence score and vertex coordinate values for each region proposal based on the first feature map to obtain ROI region information; the first ROI pooling sub-module is configured to perform a max pooling operation on the ROI region information and the first feature map to obtain fixed-size feature vectors; and the classification and regression module is configured to classify and perform position correction on the fixed-size feature vectors by using a Softmax function and a bounding box regression method respectively to obtain the category label data and the location data;
aligning, based on the category label data and the location data and by using a visual-language feature alignment module based on a frozen target detection network, image features of the cardiac anatomical structures with quality control text features to obtain query embeddings and prompts; wherein the visual-language feature alignment module includes a second ROI pooling sub-module and a querying transformer (Q-Former) sub-module; the second ROI pooling sub-module and the first ROI pooling sub-module are configured to have identical structures and synchronize with each other; the second ROI pooling sub-module is configured to perform a pooling operation on an output of the target detection model to obtain a second feature map; and the Q-Former sub-module is configured to align the image features with the quality control text features based on the second feature map and by using a per-structure input strategy to obtain the query embeddings and the prompts; and performing, by using a frozen large language model, sentence template selection, linear projection, and merging on the query embeddings and the prompts to obtain a quality control text description.

In an exemplary embodiment, the method for assessing quality of an echocardiogram image based on fusion of image and text features further includes:
calculating, based on the quality control text description, an overall quality score of the echocardiogram image, and comparing the overall quality score with a preset threshold to determine whether quality of the echocardiogram image meets a clinical diagnostic requirement; and in response to the quality of the echocardiogram image meets the clinical diagnostic requirement, outputting the echocardiogram image; otherwise, outputting an image resampling prompt information to a user.

In an embodiment, the aligning, based on the category label data and the location data and by using a visual-language feature alignment module based on a frozen target detection network, image features of the cardiac anatomical structures with quality control text features to obtain query embeddings and prompts includes:
in response to the target detection model failing to recognize a target structure in the target view image, replacing elements in the second feature map corresponding to the target view image with −1.

In an embodiment, the performing, by using a frozen large language model, sentence template selection, linear projection, and merging on the query embeddings and the prompts to obtain a quality control text description includes:
determining, based on a masked language modeling strategy, a sentence template of the large language model;
linearly projecting the query embeddings to obtain projected query embeddings; and
merging, based on the sentence template, the projected query embeddings and the prompts to obtain the quality control text description.

In an embodiment, a baseline model of the large language model is bootstrapping language-image pre-training 2 (BLIP-2).

In an embodiment, a first total loss function for training the target detection model is as follows:

$${L}_{t otal} = {L}_{c l s} + λ {L}_{reg} ;$$

$$where {L}_{cls} = - {\sum }_{i} {y}_{i} log ( {p}_{i} ) , and {L}_{reg} ( x ) = \{ \begin{matrix}0.5 {x}^{2} & if \vert x \vert < 1 \\ \vert x \vert - 0.5 & otherwise\end{matrix} ;$$

Lₜₒₜₐₗ represents the first total loss function; L_{cls} represents a cross-entropy loss function; L_{reg} (x) represents a bounding box regression loss function; λ represents a hyperparameter for balancing the cross-entropy loss function and the bounding box regression loss function; y; represents an overall ground truth label of an i^{th} sample; pᵢ represents a probability that the target detection model predicts for an i^{th} overall ground truth label; and x represents a difference between a bounding box predicted by the target detection model and a ground truth bounding box.

In an embodiment, a second total loss function for training the large language model is as follows:

$$L = \frac{1}{N} {\sum }_{i} {L}_{i} = - \frac{1}{N} {\sum }_{i} {\sum }_{c = 1}^{M} {y}_{i c} log ( {p}_{i c} ) ;$$

where L represents the second total loss function; N represents a number of samples; Lᵢ represents a loss value of an i^{th} sample; M represents a number of categories; y_{ic} represents a ground truth label for quality assessment of a c^{th} cardiac anatomical structure of the i^{th} sample; and p_{ic} represents a probability that a predicted quality assessment result for the c^{th} cardiac anatomical structure of the i^{th} sample is the ground truth label.

In an embodiment, each of the pretrained target detection model, the feature extraction network, the region proposal network, the first ROI pooling sub-module, the classification and regression module, the visual-language feature alignment module, the second ROI pooling sub-module, the Q-Former sub-module and the large language model is embodied by at least one processor and at least one memory coupled to the at least one processor, and the at least one memory stores computer programs executable by the at least one processor.

The disclosure discloses the following technical effects.

The disclosure provides a method for assessing quality of the echocardiogram image based on fusion of image and text features. By utilizing cross-domain transfer of image and text features, it solves the defects in the related art that predominantly rely on image features for assessment while neglecting the integration of text information, thereby achieving accurate and comprehensive assessment of echocardiogram image quality, and improving the interpretability of the assessment result. By introducing the target detection model, it overcomes the defects of the related art in image quality assessment, which lacks detailed assessment of anatomical structures, thereby achieving recognition and understanding of positional relationships of different anatomical structures, and achieving effective cross-domain transfer from natural images to echocardiograms. By introducing the sentence templates, it solves the shortcomings of conventional text generation methods, such as inconsistent output text formats and poor word generation accuracy, thereby ensuring the consistency of the quality control text. The output is structured data that can be directly parsed by downstream systems, which helps to improve the automation level of medical information systems.

### BRIEF DESCRIPTION OF DRAWINGS

In order to provide a clearer explanation of technical solutions in the disclosure or related art, drawings required in embodiments will be briefly introduced below. Apparently, the drawings in the following descriptions are merely some of the embodiments of the disclosure. For those skilled in the art, other drawings can be obtained based on these drawings without creative work.

FIG. 1 illustrates a flowchart of a method for assessing quality of an echocardiogram image based on fusion of image and text features according to an embodiment of the disclosure.

FIG. 2 illustrates a flowchart of implementation of the method for assessing quality of the echocardiogram image based on fusion of image and text features according to an embodiment of the disclosure.

FIG. 3 illustrates a flowchart of a target detection model according to an embodiment of the disclosure.

### DETAILED DESCRIPTION OF EMBODIMENTS

In the following, the technical scheme in the embodiments of the disclosure will be clearly and completely described with reference to the drawings. Apparently, the described embodiments are merely some of the embodiments of the disclosure, not all of the embodiments. Based on the embodiments in the disclosure, all other embodiments obtained by those skilled in the art without creative labor belong to a scope of protection of the disclosure.

An objective of the disclosure is to provide a method for assessing quality of an echocardiogram image based on fusion of image and text features. By utilizing cross-domain transfer of image and text features, an accurate and comprehensive echocardiogram image quality assessment report is generated, thereby enhancing the interpretability and granularity of the assessment results. By introducing a target detection model, the system is enabled to recognize and understand positional relationships of different anatomical structures within medical images, thereby providing rich medical domain prior knowledge for subsequent quality assessment, and achieving effective cross-domain transfer from natural images to echocardiograms. By introducing sentence templates, the consistency of the quality control text is ensured.

In order to make the above object, features and advantages of the disclosure more obvious and easy to understand, the disclosure will be further described in detail with the drawings and specific embodiments.

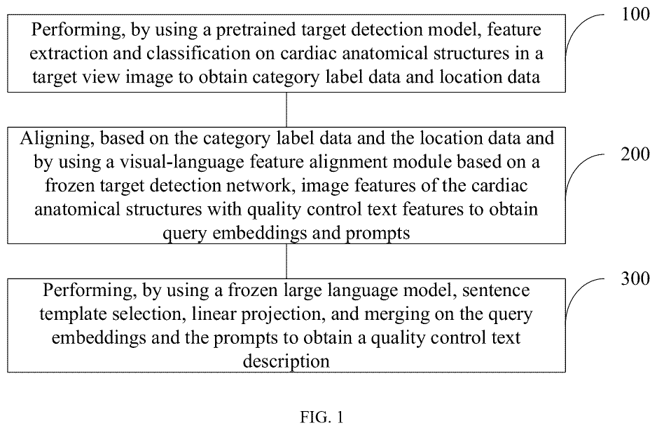

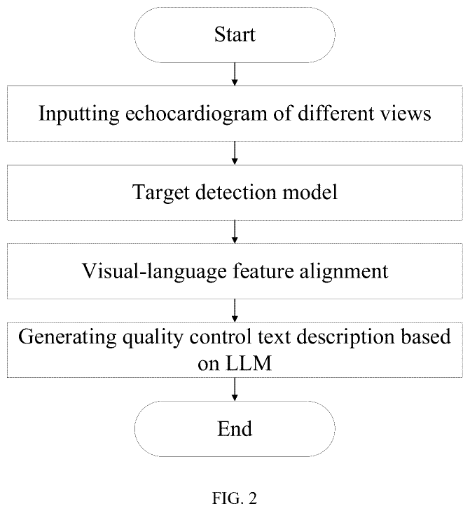

FIG. 1 illustrates a flowchart of a method for assessing quality of an echocardiogram image based on fusion of image and text features according to an embodiment of the disclosure. FIG. 2 illustrates a flowchart of implementation of the method for assessing quality of the echocardiogram image based on fusion of image and text features according to an embodiment of the disclosure. As shown in FIG. 1 and FIG. 2, the disclosure provides a method for assessing quality of an echocardiogram image based on fusion of image and text features, including the following steps 100-300.

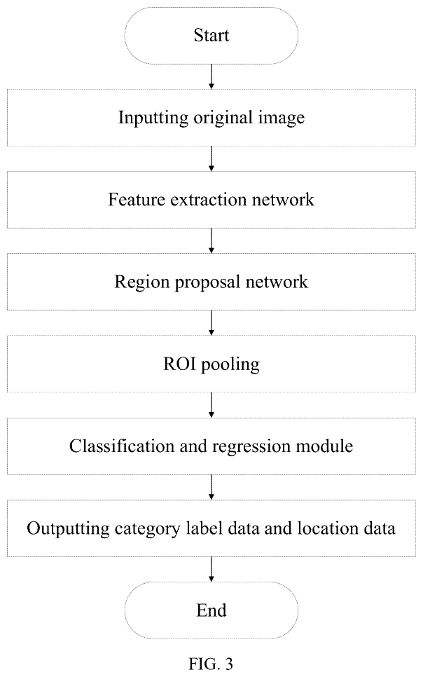

In step 100, a pretrained target detection model is used to perform feature extraction and classification on cardiac anatomical structures in a target view image to obtain category label data and location data. The target detection model (referring to FIG. 3) includes a feature extraction network, a region proposal network, a first ROI pooling sub-module, and a classification and regression module. The feature extraction network is configured to extract feature information from the cardiac anatomical structures in the target view image to obtain a first feature map. The region proposal network is configured to calculate a foreground confidence score and vertex coordinate values for each region proposal based on the first feature map to obtain ROI region information. The first ROI pooling sub-module is configured to perform a max pooling operation on the ROI region information and the first feature map to obtain fixed-size feature vectors. The classification and regression module is configured to classify and perform position correction on the fixed-size feature vectors by using a Softmax function and a bounding box regression method respectively to obtain the category label data and the location data.

In step 200, image features of the cardiac anatomical structures are aligned with quality control text features to obtain query embeddings and prompts based on the category label data and the location data and by using a visual-language feature alignment module based on a frozen target detection network. The visual-language feature alignment module includes a second ROI pooling sub-module and a Q-Former sub-module. The second ROI pooling sub-module and the first ROI pooling sub-module are configured to have identical structures and synchronize with each other. The second ROI pooling sub-module is configured to perform a pooling operation on an output of the target detection model to obtain a second feature map. The Q-Former sub-module is configured to align the image features with the quality control text features based on the second feature map and by using a per-structure input strategy to obtain the query embeddings and the prompts.

In step 300, a frozen large language model is used to perform sentence template selection, linear projection, and merging on the query embeddings and the prompts to obtain a quality control text description.

In an embodiment, the step of aligning, based on the category label data and the location data and by using the visual-language feature alignment module based on the frozen target detection network, the image features of the cardiac anatomical structures with the quality control text features to obtain the query embeddings and prompts includes the following step.

In response to the target detection model failing to recognize a target structure in the target view image, elements in the second feature map corresponding to the target view image are replaced with −1.

Specifically, the step of performing, by using the frozen large language model, sentence template selection, linear projection, and merging on the query embeddings and the prompts to obtain the quality control text description includes the following steps.

A sentence template of the large language model is determined based on a masked language modeling strategy. The query embeddings are linearly projected to obtain projected query embeddings. The projected query embeddings and the prompts are merged to obtain the quality control text description.

In an embodiment, a baseline model of the large language model is BLIP-2.

In an embodiment, a first total loss function for training the target detection model is as follows:

$${L}_{total} = {L}_{c l s} + λ {L}_{reg} ;$$

$$where {L}_{cls} = - {\sum }_{i} {y}_{i} log ( {p}_{i} ) , and {L}_{reg} ( x ) = \{ \begin{matrix}0.5 {x}^{2} & if \vert x \vert < 1 \\ \vert x \vert - 0.5 & otherwise\end{matrix} ;$$

Lₜₒₜₐₗ represents the first total loss function; L_{cls} represents a cross-entropy loss function; L_{reg} (x) represents a bounding box regression loss function; λ represents a hyperparameter for balancing the cross-entropy loss function and the bounding box regression loss function; y; represents an overall ground truth label of an i^{th} sample; pᵢ represents a probability that the target detection model predicts for an i^{th} overall ground truth label; and x represents a difference between a bounding box predicted by the target detection model and a ground truth bounding box.

In an embodiment, a second total loss function for training the large language model is as follows:

$$L = \frac{1}{N} {\sum }_{i} {L}_{i} = - \frac{1}{N} {\sum }_{i} {\sum }_{c = 1}^{M} {y}_{i c} log ( {p}_{i c} ) ;$$

where L represents the second total loss function; N represents a number of samples; Lᵢ represents a loss value of an i^{th} sample; M represents a number of categories; y_{ic} represents a ground truth label for quality assessment of a c^{th} cardiac anatomical structure of the i^{th} sample; and p_{ic} represents a probability that a predicted quality assessment result for the c^{th} cardiac anatomical structure of the i^{th} sample is the ground truth label.

Optionally, compared with conventional one-stage or two-stage target detection models, a scale-aware trident network for target detection (TridentNet) demonstrates superior performance when dealing with multi-scale target detection tasks. For the task of detecting multiple cardiac ultrasound anatomical structures, since valve structures are relatively small in area while atrial and ventricular structures are larger, TridentNet is adopted as a baseline model for the target detection model.

Specifically, the pretrained target detection model is constructed. TridentNet is used as the baseline model for the target detection model. The pre-trained target detection model mainly includes: a feature extraction network, a region proposal network, a ROI pooling, and a classification and regression module. In the feature extraction network, rich feature information is extracted from the input image through a set of convolutional layers, rectified linear unit (ReLU) activation functions, and pooling operations to obtain a feature map for subsequent processing by the region proposal network and a pooling network. In the region proposal network, the obtained feature map is input and information for multiple ROI regions is output, which specifically includes a confidence score that each region proposal is determined as a foreground (i.e., foreground confidence score) and vertex coordinate values of the region proposals for providing key information for subsequent processing. In the ROI pooling, the ROI regions output by the region proposal network and the feature map output by the feature extraction network are taken as inputs, a max pooling operation is performed on each detection box, thereby processing structures in different sizes from the original feature map into fixed-size feature vectors, which facilitates the subsequent classification and regression of the detection boxes. In the classification and regression module, the feature vectors from the ROI pooling are received as input, the images are classified by using the Softmax function, and the bounding box regression is used to correct a precise position of the object. Finally, this module outputs a category label for each ROI and a precise position of the category label in the image.

In an embodiment, the max pooling operation includes the following steps.

First, for each ROI region information output by the region proposal network, a corresponding region is extracted from the first feature map based on location data (i.e., vertex coordinate values) of the ROI. Specifically, when the ROI has bounding box coordinates (x₁, y₁, x₂, y₂), where (x₁, y₁) represents top-left corner coordinates, and (x₂, y₂) represents bottom-right corner coordinates, the corresponding region is extracted from the first feature map based on these coordinates.

Subsequently, the extracted ROI region is divided into H×W grid sub-regions, where H and W represent a target height and a target width of an output feature vector, respectively. For example, the ROI region can be divided into a 7×7 grid, resulting in 49 equally sized sub-regions.

Then, the max pooling operation is performed independently on each sub-region. Specifically, a maximum value among all elements within each sub-region is selected as a representative value for the sub-region. A mathematical expression is as follows:

$${v}_{i , j} = {max}_{( m , n ) ∈ {R}_{i , j}} f ( m , n ) ;$$

where v_{i,j} represents an output value of the feature vector at position (i, j) after the max pooling operation; R_{i,j} represents a (i, j)^{th} sub-region in the grid; f (m, n) represents a feature value at position (m, n) in the first feature map; and max represents a maximum value operation.

Finally, maximum values from all sub-regions are concatenated to form a fixed-size feature vector having dimensions C×H×W, where C represents a number of channels of the first feature map. The fixed-size feature vector is subsequently input to the classification and regression module for further processing.

Through the aforementioned steps, cardiac anatomical structures of different sizes and aspect ratios are unified into feature vectors of identical size, thereby facilitating subsequent classification and bounding box regression operations.

In an embodiment, the Softmax function includes the following steps.

First, the fixed-size feature vector output by the first ROI pooling sub-module is input into a fully connected layer to obtain class logits. Specifically, the feature vector is assumed as f, the class logits are calculated as follows:

$$z = {W}_{c} f + {b}_{c} ;$$

where z=[z₁, z₂, . . . , z_{K}] represents a class logits vector; K represents a number of categories, including a background category; W_{c} represents a weight matrix of the fully connected layer; and b_{c} represents a bias vector.

Subsequently, the Softmax function is applied to the class logits to obtain a probability distribution over the categories. The calculation formula is as follows:

$${p}_{k} = \frac{{e}^{{z}_{k}}}{{\sum }_{j = 1}^{K} {e}^{{z}_{j}}} ;$$

where pₖ represents a probability that the ROI belongs to a k^{th} category; zₖ represents a logits value for the k^{th} category; and e represents a natural exponential function.

Finally, a category label with a highest probability is selected as a classification result for the current ROI:

$$\hat{y} = arg {max}_{k} {p}_{k} ;$$

where ŷ represents a predicted category label.

In an embodiment, the bounding box regression method includes the following steps.

First, the fixed-size feature vector is input into another fully connected layer to obtain bounding box regression parameters. A specific formula is expressed as follows:

$$t = {W}_{r} f + {b}_{r} ;$$

where t=[tₓ, t_{y}, t_{w}, tₕ] represents a bounding box regression parameter vector; Wᵣ represents a weight matrix of the regression layer; and bᵣ represents a corresponding bias vector.

Subsequently, a position of the ROI region proposal refined by using the bounding box regression parameters. When an original ROI region proposal has coordinates (x, y, w, h), where (x, y) represents center coordinates and (w, h) represents a width and a height, refined bounding box coordinates (\hat{x}, ŷ, ŵ, ĥ) are calculated as follows:

$$\hat{x} = {t}_{x} \cdot w + x ;$$

$$\hat{y} = {t}_{y} \cdot h + y ;$$

$$\hat{w} = w \cdot {e}^{{t}_{w}} ;$$

$$\hat{h} = h \cdot {e}^{{t}_{h}} ;$$

where tₓ and t_{y} represent center offset parameters; t_{w} and to represent scale transformation parameters; and e represents the natural exponential function.

Finally, the refined bounding box coordinates are converted into an (x₁, y₁, x₂, y₂) format, where (x₁, y₁) represents the top-left corner coordinates and (x₂, y₂) represents the bottom-right corner coordinates:

$${x}_{1} = \hat{x} - \frac{\hat{w}}{2} , {y}_{1} = \hat{y} - \frac{\hat{h}}{2} ;$$

$${x}_{2} = \hat{x} - \frac{\hat{w}}{2} , {y}_{2} = \hat{y} - \frac{\hat{h}}{2} .$$

Through the aforementioned steps, the classification and regression module outputs the category label data and the precise location data for each ROI, thereby achieving accurate recognition and localization of the cardiac anatomical structures.

In an embodiment, a multimodal model BLIP-2 is used as the baseline model for the visual-language echocardiogram quality control model (the baseline model of the large language model). Specifically, vision represents image features of different cardiac anatomical structures in the echocardiogram, and language represents the textual descriptions concerning the clarity and integrity of different cardiac anatomical structures. The learnable Q-Former is used to achieve cross-domain feature transfer between the visual and language modalities and is a key module in the BLIP-2 model for realizing this cross-domain transfer. In order to achieve precise alignment between the image features of the cardiac anatomical structures and the quality control text features, a frozen pretrained target detection module is first introduced. Next, an ROI pooling module is cascaded after the target detection network, which has the same structure as the ROI pooling module in the target detection network and shares the same pretrained weights, so that the feature vectors input to the Q-Former have a fixed size. Secondly, for cardiac anatomical structures that the target detection module fails to recognize, a special preprocessing method is adopted, that is, they are replaced with a vector of the same size as the feature vector but with all elements set to −1. This preprocessing method is based on the following consideration. Since the target detection network is pretrained on a preset ImageNet dataset and fine-tuned on high-quality echocardiogram data. If certain structures are not recognized during the detection process, it often indicates poor quality of these structures in the input image. Therefore, inputting a vector with all element values as −1 as the feature representation of these structures into the Q-Former not only conforms to the actual situation but also helps the model make reasonable inferences and predictions about these structures during the learning process. Finally, the per-structure input training strategy is adopted, the Q-Former receives the feature maps of each structure as independent inputs, which means that for a complete image, the Q-Former needs to receive and process N (number of samples) feature maps. Through the powerful cross-domain transfer capability of the Q-Former, precise alignment between the image features of different cardiac anatomical structures and the corresponding quality control text features is achieved.

In an embodiment, assessment text is generated based on the large language model. First, the query embeddings output by the Q-Former sub-module is linearly projected through a fully connected layer to align its dimensionality with the text embedding dimension of the large language model (LLM) in BLIP-2. This projection result serves as a soft visual prompt, the LLM is adjusted based on the visual representations extracted by the Q-Former. Next, the projected query embeddings are merged with the prompts. The Q-Former acts as an information bottleneck in this process, transmits only the most valuable visual information to the LLM while filters out irrelevant visual details, thereby achieving effective fusion of visual and textual information. Secondly, for visual-language models, the prompt is key to guiding the model to generate text output. On one hand, it can specify the model to perform different tasks, thereby generating different output answers; on the other hand, it can also provide certain reference knowledge for the model. In the disclosure, the prompt is constructed by using a format “image introduction”+ “structure introduction”+ “quality control result”, specifically: “This is a <view> showing the <structure>, it's clarity and integrity are assessed as follows:”, so that the large language model can better understand the morphological features of each structure output by the Q-Former, thereby ensuring structural consistency between the prompts and the input feature maps of the Q-Former, further enhancing the model's performance in text generation and image understanding. Finally, a sentence template is designed for the LLM based on the masked language modeling strategy, the parts of the text describing image quality is replaced with specific <mask> tokens. The model, based on the remaining content of the sentence, combined with the feature information extracted from the image and the prompts, completes the template into a full description. These descriptions are then merged to form a comprehensive echocardiogram quality assessment report.

In an exemplary embodiment, the generated echocardiogram quality assessment report of the disclosure can be further utilized. For example, the quality control text description can be automatically imported into an electronic medical record (EMR) system of a hospital as a part of patient imaging records for clinical doctors to review. In addition, the quality control text description can also be used as label data to automate the construction of large-scale medical imaging report pairing datasets for training other artificial intelligence (AI) assisted diagnostic models. Through these methods, the disclosure not only achieves automated assessment of image quality, but also promotes the standardization and intelligent flow of medical data, thereby improving the efficiency and data utilization level of the entire clinical workflow.

In an embodiment, the method for assessing quality of an echocardiogram image based on fusion of image and text features further includes: aligning the quality control text description with a corresponding echocardiogram image based on a timestamp to obtain aligned data, and automatically packaging the alleged data into a standardized teaching case unit; uploading the teaching case unit to a database of a medical imaging education platform, and automatically assigning teaching tags based on quality evaluation results for each anatomical structure within the quality control text description, where the teaching tags include high-quality example, blurred boundary example, and missing structure example; and in response to a query request from a medical student on the medical imaging education platform, retrieving and pushing matching teaching case units from the database based on the teaching tags.

In an embodiment, the method for assessing quality of an echocardiogram image based on fusion of image and text features further includes: encoding the quality control text description into a lightweight structured data format, such as JavaScript object notation (JSON), to obtain encoded data, and binding the encoded data with an original echocardiogram video stream as metadata; transmitting the quality control text description synchronously with the echocardiogram video stream over a telemedicine network; and parsing the quality control text description on a remote consultation terminal device, and displaying a quality status of each cardiac anatomical structure in real-time within an overlay of a video playback interface by using visual icons or color coding for highlighting.

In an embodiment, the method for assessing quality of an echocardiogram image based on fusion of image and text features further includes: parsing the quality control text description in real-time to identify target anatomical structures with quality evaluations of invisible or blurred; automatically generating an adjustment suggestion for the target anatomical structures based on a pre-stored probe operation knowledge base, where the adjustment suggestion includes move probe leftward, increase gain, and adjust angle; and providing the adjustment suggestion to an operator of an ultrasound device in real-time via voice prompts or on-screen graphical instructions.

The beneficial effects of the disclosure are as follows.
(1) The visual-language model is introduced for echocardiogram quality assessment. The disclosure innovatively applies a visual-language model to echocardiogram quality assessment. Through cross-domain transfer of image and text features, the accurate and comprehensive echocardiogram image quality assessment report is generated, which can quantitatively assess the clarity and integrity of different cardiac anatomical structures across multiple ultrasound views, thereby significantly improving the reliability and clinical application value of the assessment results.
(2) Medical prior knowledge is introduced into the model. In the first stage of model training, the disclosure introduces a target detection task, so that the model can recognize and understand the positional relationships of different cardiac anatomical structures in medical images. This provides rich medical domain prior knowledge for subsequent quality assessment, thereby achieving effective cross-domain transfer from natural images to echocardiograms.
(3) The masked modeling strategy is adopted to ensure consistency of quality control text. The disclosure adopts the masked language modeling strategy to provide a predefined text generation template. In the template, key content is placeholderized by using <mask> tokens. On one hand, this fixes the output format, thereby ensuring consistency in the generated text structure; on the other hand, by having the model fill in the <mask> tokens, the model is guided to generate appropriate words or phrases more accurately based on the context. This strategy effectively ensures that the descriptions of each anatomical structure comply with the specifications and consistency requirements of the quality control report, thereby making the output text not only structurally fixed but also accurate in description and standardized for easy interpretation.

In the disclosure, by utilizing cross-domain transfer of image and text features, the accurate and comprehensive echocardiogram image quality assessment report is generated, thereby enhancing the interpretability and granularity of the assessment results. By introducing a target detection model, the system is enabled to recognize and understand positional relationships of different cardiac anatomical structures within medical images, thereby providing rich medical domain prior knowledge for subsequent quality assessment, and achieving effective cross-domain transfer from natural images to echocardiograms. By introducing sentence templates, the consistency of the quality control text is ensured.

The various embodiments in this specification are described in a progressive manner, with each embodiment focusing on explaining the differences from other embodiments. The same or similar parts between the various embodiments can be referred to mutually.

Specific examples are used in this document to explain the principles and implementations of the disclosure. The descriptions of the above embodiments are only intended to help understand the method of the disclosure and its core ideas. At the same time, for those skilled in the art, modifications may be made to the specific embodiments and application scope based on the ideas of the disclosure. In summary, the content of this specification should not be construed as limiting the disclosure.

What is claimed is:

1. A method for assessing quality of an echocardiogram image based on fusion of image and text features, comprising:
performing, by using a pretrained target detection model, feature extraction and classification on cardiac anatomical structures in a target view image to obtain category label data and location data; wherein the target detection model comprises: a feature extraction network, a region proposal network, a first region of interest (ROI) pooling sub-module, and a classification and regression module; the feature extraction network is configured to extract feature information from the cardiac anatomical structures in the target view image to obtain a first feature map; the region proposal network is configured to calculate a foreground confidence score and vertex coordinate values for each region proposal based on the first feature map to obtain ROI region information; the first ROI pooling sub-module is configured to perform a max pooling operation on the ROI region information and the first feature map to obtain fixed-size feature vectors; and the classification and regression module is configured to classify and perform position correction on the fixed-size feature vectors by using a Softmax function and a bounding box regression method respectively to obtain the category label data and the location data;
aligning, based on the category label data and the location data and by using a visual-language feature alignment module based on a frozen target detection network, image features of the cardiac anatomical structures with quality control text features to obtain query embeddings and prompts; wherein the visual-language feature alignment module comprises a second ROI pooling sub-module and a querying transformer (Q-Former) sub-module; the second ROI pooling sub-module and the first ROI pooling sub-module are configured to have identical structures and synchronize with each other; the second ROI pooling sub-module is configured to perform a pooling operation on an output of the target detection model to obtain a second feature map; and the Q-Former sub-module is configured to align the image features with the quality control text features based on the second feature map and by using a per-structure input strategy to obtain the query embeddings and the prompts; and
performing, by using a frozen large language model, sentence template selection, linear projection, and merging on the query embeddings and the prompts to obtain a quality control text description.

2. The method for assessing quality of the echocardiogram image based on fusion of image and text features as claimed in claim 1, wherein the aligning, based on the category label data and the location data and by using a visual-language feature alignment module based on a frozen target detection network, image features of the cardiac anatomical structures with quality control text features to obtain query embeddings and prompts comprises:
in response to the target detection model failing to recognize a target structure in the target view image, replacing elements in the second feature map corresponding to the target view image with −1.

3. The method for assessing quality of the echocardiogram image based on fusion of image and text features as claimed in claim 1, wherein the performing, by using a frozen large language model, sentence template selection, linear projection, and merging on the query embeddings and the prompts to obtain a quality control text description comprises:
determining, based on a masked language modeling strategy, a sentence template of the large language model;
linearly projecting the query embeddings and the prompts to obtain projected query embeddings and projected prompts; and
merging, based on the sentence template, the projected query embeddings and the projected prompts to obtain the quality control text description.

4. The method for assessing quality of the echocardiogram image based on fusion of image and text features as claimed in claim 1, wherein a baseline model of the large language model is bootstrapping language-image pre-training 2 (BLIP-2).

5. The method for assessing quality of the echocardiogram image based on fusion of image and text features as claimed in claim 1, wherein a first total loss function for training the target detection model is as follows:
$${L}_{total} = {L}_{cls} + λ {L}_{reg} ;$$
$$wherein {L}_{cls} = - {\sum }_{i} {y}_{i} log ( {p}_{i} ) , and {L}_{reg} ( x ) = \{ \begin{matrix}0.5 {x}^{2} & if \vert x \vert < 1 \\ \vert x \vert - 0.5 & otherwise\end{matrix} ;$$
Lₜₒₜₐₗ represents the first total loss function; L_{cls} represents a cross-entropy loss function; L_{reg} (x) represents a bounding box regression loss function; λ represents a hyperparameter for balancing the cross-entropy loss function and the bounding box regression loss function; y; represents an overall ground truth label of an i^{th} sample; pᵢ represents a probability that the target detection model predicts for an i^{th} overall ground truth label; and x represents a difference between a bounding box predicted by the target detection model and a ground truth bounding box.

6. The method for assessing quality of the echocardiogram image based on fusion of image and text features as claimed in claim 1, wherein a second total loss function for training the large language model is as follows:
$$L = \frac{1}{N} {\sum }_{i} {L}_{i} = - \frac{1}{N} {\sum }_{i} {\sum }_{c = 1}^{M} {y}_{i c} log ( {p}_{i c} ) ;$$
wherein L represents the second total loss function; N represents a number of samples; Lᵢ represents a loss value of an i^{th} sample; M represents a number of categories; y_{ic} represents a ground truth label for quality assessment of a c^{th} cardiac anatomical structure of the i^{th} sample; and p_{ic} represents a probability that a predicted quality assessment result for the c^{th} cardiac anatomical structure of the i^{th} sample is the ground truth label.
